(19) United States
(12) Patent Application Publication
(10) Pub. No.: US 2025/0162800 A1
(43) Pub. Date: May 22, 2025

(54) Adjustment Method and Device

(71) Applicant: AutoStore Technology AS, Nedre Vats (NO)

(72) Inventor: Kjetil Gilje, Sandeid (NO)

(21) Appl. No.: 18/840,323

(22) PCT Filed: Feb. 10, 2023
(86) PCT No.: PCT/EP2023/053383

§ 371 Date: Aug. 21, 2024

(30) Foreign Application Priority Data
Feb. 23, 2022 (NO) 20220242

(51) Int. Cl. B65G 1/04

(52) U.S. Cl. CPC B65G 1/0471; B65G 1/0492

(57) ABSTRACT

The present invention relates to an automated storage and retrieval system (1) comprising a framework structure (100) comprising a first framework element (61) having a first opening (61a), a second framework element (62) having a second opening (62a), and a storage volume comprising storage columns (105) for storing stacks (107) of storage containers (106). The automated storage and retrieval system (1) comprises a framework adjuster (10) comprising a double-threaded rod (20) having a first threaded section (21) threaded in a first direction, and a second threaded section (22) threaded in a second direction opposite of the first direction. The first threaded section (21) of the double-threaded rod (20) is engaged in the first opening (61a) of the first framework element (61) and the second threaded section (22) of the double-threaded rod (20) is engaged in the second opening (62a) of the second framework element (62). The framework adjuster (10) comprises an adjustment interface (25) for adjusting a distance (D) between the first framework element (61) and the second framework element (62) by rotation of the double-threaded rod (20).

### FIELD OF THE INVENTION

The present invention relates to an automated storage and retrieval system. The present invention relates to a method for adjusting a distance between a first framework element and a second framework element of a framework structure of an automated storage and retrieval system. The present invention also relates to a method for installing a port frame in a framework structure of an automated storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c, 401b,401c can be lifted and lowered, so that the first set of wheels 201b,301b,401b and/or the second set of wheels 201c,301c, 401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

In some situations, it is desired to retrofit an access station in the framework structure 100. Typically, this requires cutting of upright members 102 in order to fit a port frame for the access station below the upright members 102. This cutting must be very accurate to ensure a correct horizontal alignment of the rail system 108 above the upright members 102, and is therefore a tedious and time-consuming operation. In addition, some port frames tend to “sag” and/or come out of alignment during years of operation. Hence, upright members 102 may require later adjustments.

One way of solving the above problem is to provide the port frame with adjustable feet. However, by adjusting the feet of the port frame according to inaccurately cut members 102 the result will be an unlevelled port frame, which may cause problems when operating the access station.

One object of the present invention is to provide an alternative way of ensuring a correct horizontal alignment of the rail system.

### SUMMARY OF THE INVENTION

The present invention relates to a an automated storage and retrieval system comprising a framework structure comprising a first framework element having a first opening, a second framework element having a second opening, and a storage volume comprising storage columns for storing stacks of storage containers;
characterized in that the automated storage and retrieval system comprises a framework adjuster comprising a double-threaded rod having a first threaded section threaded in a first direction, and a second threaded section threaded in a second direction opposite of the first direction;
wherein the first threaded section of the double-threaded rod is engaged in the first opening of the first framework element and the second threaded section of the double-threaded rod is engaged in the second opening of the second framework element; and
wherein the framework adjuster comprises an adjustment interface for adjusting a distance between the first framework element and the second framework element by rotation of the double-threaded rod.

In one aspect, the rod is a double end threaded bolt.

In one aspect, the rod has a central longitudinal axis.

In one aspect, the adjustment interface is an interface configured to be engaged by a tool to enable rotation of the double-threaded rod about its longitudinal axis.

In one aspect:
the first threaded section is provided on a first end portion of the double-threaded rod;
the second threaded section is provided on a second end portion of the double-threaded rod; and
the adjustment interface is located between the first threaded section and the second threaded section.

In one aspect, the adjustment interface comprises a cross-sectional profile provided in the outer surface of the rod.

The cross-sectional profile may comprise a section having flattened surfaces, a section having another cross-sectional shape to which torque can be applied in order to rotate the rod. Such cross-sectional shapes may be a square cross-section, a hexagonal cross-section, etc.

In one aspect, the adjustment interface comprises a hole in the double-threaded rod.

In one aspect, the hole has an orientation axis perpendicular to the longitudinal axis of the rod. The hole may be a recess formed in the rod into which a pin-shaped tool may be inserted or it may a through hole through which a pin-shaped tool may be inserted. Such a pin-shaped tool may be a screw-driver.

In one aspect, the adjustment interface is provided as an adjustment interface element fixed radially outside of the rod.

In one aspect, the adjustment interface element is a nut fixed to the rod, in order to provide rotation of the rod around its longitudinal axis when rotating the adjustment interface element around the longitudinal axis of the rod.

The adjustment interface element may be fixed to the rod by welding, by an adhesive, by means of split pins, a jam nut, a locking nut etc.

In one aspect, the framework adjuster comprises a locking nut secured to the first threaded section or to the second threaded section, wherein the locking nut is configured to lock the double-threaded rod in place relative to the first framework element and/or the second framework element.

Hence, when the locking nut is tightened up against the first framework element and/or the second framework element, e.g. through rotation of the locking nut, relative rotation between the double-threaded rod and the respective framework element is prevented. In this way, the distance between the first and second framework elements that is controlled by the framework adjuster can be locked-in. Further rotation of the double-threaded rod relative to the first and/or second framework elements may be permitted by loosening the locking nut relative to the respective framework element. The locking nut may also provide additional support for holding the first and/or second framework elements in place relative to double-threaded rod by providing a thrust force to counteract a force exerted on the framework adjuster by the first and/or second framework element.

In one aspect:
the first framework element comprises a first longitudinal recess;
the second framework element comprises a second longitudinal recess; and
the framework adjuster comprises a guide element engaged in the first longitudinal recess and in the second longitudinal recess for preventing relative rotation between the first framework element and the second framework element.

In one aspect:
the first longitudinal recess and the first opening are parallel to each other; and/or
the second longitudinal recess and the second opening are parallel to each other.

In one aspect:
the first longitudinal recess and the first opening are perpendicular to each other; and/or
the second longitudinal recess and the second opening are perpendicular to each other.

In one aspect, the guide element is slidably engaged in the first longitudinal recess and/or in the second longitudinal recess.

In one aspect, the guide element is slidably engaged in the first longitudinal recess and/or in the second longitudinal recess during adjustment of the distance between the first framework element and the second framework element during rotation of the double-threaded rod.

In one aspect, the first longitudinal recess and the first opening are parallel to each other, while the second longitudinal recess and the second opening are perpendicular to each other. Here, the guide element may be slidingly engaged with the first longitudinal recess while the guide element is stationary with respect to the second longitudinal recess during the adjustment of the distance between the first framework element and the second framework element by rotation of the double-threaded rod.

In one aspect, the framework adjuster comprises a guide fastener for securing the guide element to the first longitudinal recess and/or the second longitudinal recess.

In one aspect, both the first longitudinal recess and the first opening are parallel to each other, and the second longitudinal recess and the second opening are parallel to each other. Here, the guide element may be slidingly engaged with the first longitudinal recess and the guide element is slidingly engaged with respect to the second longitudinal recess during the adjustment of the distance between the first framework element and the second framework element by rotation of the double-threaded rod. Here, to avoid unintentional sliding of the guide element out of engagement with the first longitudinal recess or the second longitudinal recess, the guide fastener can be used.

In one aspect, the distance between the first framework element and the second framework element is adjusted by rotation of the double-threaded rod relative to the first framework element and the second framework element. Hence, there is no need to rotate the first framework element and/or the second framework element. Consequently, the guide element can slide in the recesses relative to the framework elements to permit adjustment of distance without allowing relative rotation of the framework elements.

In one aspect, the automated storage and retrieval system comprises:
a rail system provided on top of and supported by the framework elements on which container handing vehicles can be operated and move around on, wherein the distance between first framework element and second framework element of the framework structure, as set by the framework adjuster, is such that the rail system is aligned horizontally.

In one aspect, the automated storage and retrieval system comprises container handling vehicles operating and moving on the rail system.

In one aspect, the first threaded section and the second threaded section are self-tapping threaded sections.

Hence, the first opening and the second opening do not need threads to be cut into them before introduction of the double-threaded rod, as the double-threaded rod will create threads in the first opening and the second opening as the double-threaded rod is driven into the openings by rotation. In another embodiment, the openings may be provided with threads prior to engagement with the double-threaded rod so that the threaded sections of the rod may be threadedly engaged with the openings.

In one aspect, the first framework element is one of an upright member of the framework structure, a horizontal member of the framework structure, a rail supporting member for supporting the rail system, or a port frame element. The rail supporting member may be integrated with the rails or may be a separate element supporting the rails from below.

In one aspect, the second framework element is the upright member of the framework structure, a horizontal member of the framework structure, a rail supporting member for supporting the rail system, or a port frame element. The rail supporting member may be integrated with the rails or may be a separate element supporting the rails from below. The first and second framework elements may be of the same type, or may be different.

In one aspect, at least one of the first framework element and the second framework element extends in the vertical direction. One or both of the first and second framework elements may extend in the horizontal direction.

In one aspect, the first framework element and/or the second framework element are metal profiles. In one aspect, the metal profiles are extruded aluminum profiles. One example of such a profile is the Bosch Rexroth aluminum strut.

In one aspect, the distance is a vertical distance between the first framework element and the second framework element between the first framework element and the second framework element by rotation of the double-threaded rod.

In one aspect, one of the first framework element and the second framework element is arranged vertically above the other one of the first framework element and the second framework element.

In one aspect, the framework structure comprises upright members; wherein the storage volume is provided between the members and wherein the rail system is provided on top of the upright members.

In one aspect, the framework structure comprises:
at least four first framework elements being upright members cut to allow installation of an access station;
at least four second framework elements defining at least a portion of the access station;
at least four framework adjusters, wherein each of the first framework elements is secured to each one of the second framework elements by means of each one of the framework adjusters.

In one aspect, the framework structure comprises a third framework element of a different dimension than the first framework element, wherein the framework adjuster comprises an adapter for connecting the third framework element to the first framework element.

The present invention also relates to a method for adjusting a distance between a first framework element and a second framework element of a framework structure of an automated storage and retrieval system, wherein the method comprises the steps of:
engaging a first threaded section of a double-threaded rod into an opening of the first framework element, wherein the first threaded section is threaded in a first direction;
engaging a second threaded section of the double-threaded rod into an opening of the second framework element, wherein the second threaded section is threaded in a second direction opposite of the first direction;
rotating the double-threaded rod for adjusting the distance between the first framework element and the second framework element.

In one aspect, the step of rotating the double-threaded rod comprises the steps of:
rotating the double-threaded rod via an adjustment interface.

In one aspect, the step of rotating the double-threaded rod comprises the steps of:
rotating the double-threaded rod by means of a tool via the adjustment interface.

The present invention also relates to a method for installing a port frame in a framework structure of an automated storage and retrieval system, the method comprising the steps of:
cutting first framework elements above a desired location for the port frame;
inserting the port frame into the compartment below the cut first framework elements;
engaging a first threaded section of a double-threaded rod into an opening of the respective the first framework elements, wherein the first threaded section is threaded in a first direction;
engaging a second threaded section of the double-threaded rod into corresponding openings of a respective second framework elements of the port frame, wherein the second threaded section is threaded in a second direction opposite of the first direction;
rotating the double-threaded rod for adjusting the distance between the first framework element and the second framework element.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5a illustrates a sideview of a framework structure with a port frame, wherein one upright column is too short, causing a gap between the rail system and the upright column. It is also illustrated how an embodiment of the present invention may be used to solve this problem.

FIG. 5b illustrates a sideview a framework structure with a port frame, wherein a leg of the port frame has been adjusted, causing an unlevelled port frame.

FIG. 6 illustrates a perspective side view of the first embodiment being used to adjust two vertical members.

FIG. 7a illustrates an exploded perspective side view of the first embodiment being used to adjust one vertical and one horizontal member.

FIG. 7b illustrates the parts of FIG. 7a assembled.

FIGS. 8a and 8b illustrate exploded perspective side views of the first embodiment being secured to a corner between two horizontal members.

FIG. 9 illustrates a perspective view of how the first embodiment is used to adjust four upright members above a port frame.

FIG. 10a and FIG. 10b illustrate an enlarged view of the dashed box A in FIG. 9 (exploded view and assembled view respectively).

FIG. 11 illustrates a perspective view of an alignment element.

FIG. 12 shows the alignment element of FIG. 11 in situ in the arrangement shown in FIG. 10b.

FIG. 13a and FIG. 13b show alternative embodiments of framework adjuster.

FIG. 13c shows an alternative embodiment of the guide element.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

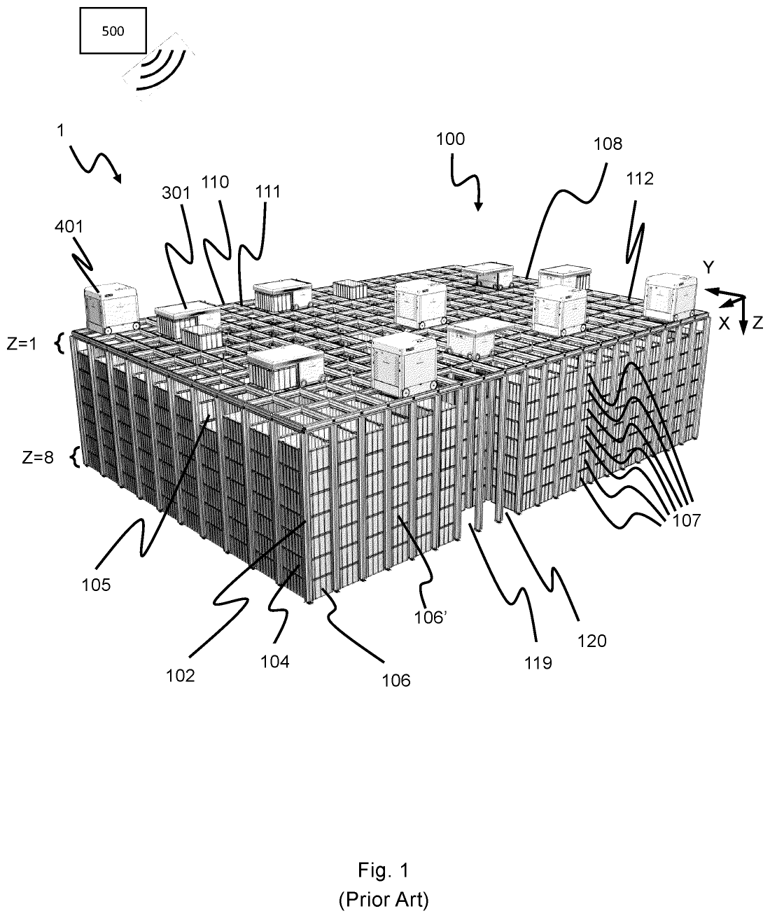

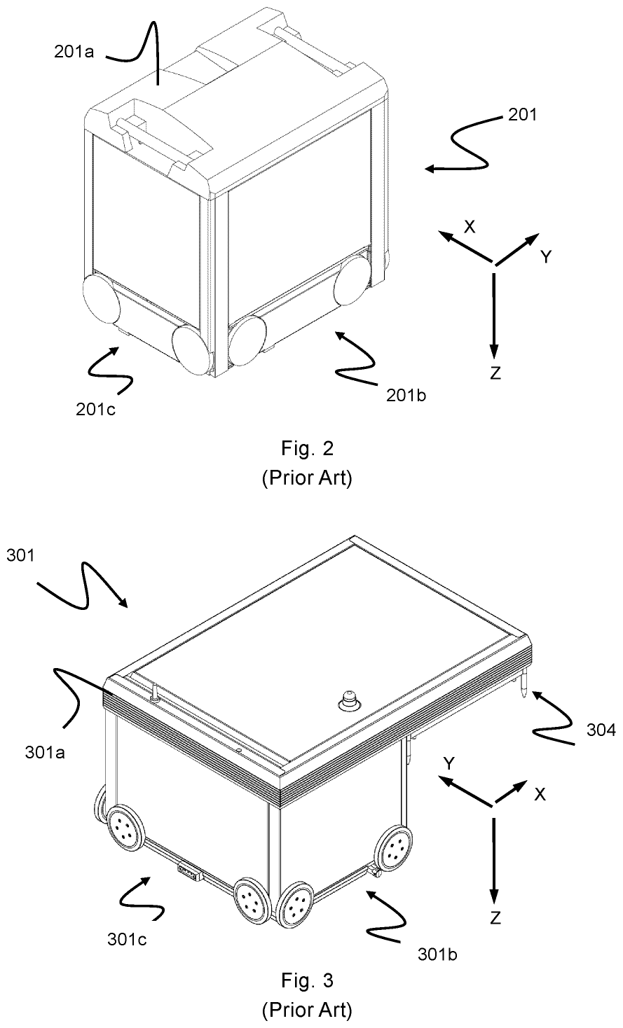

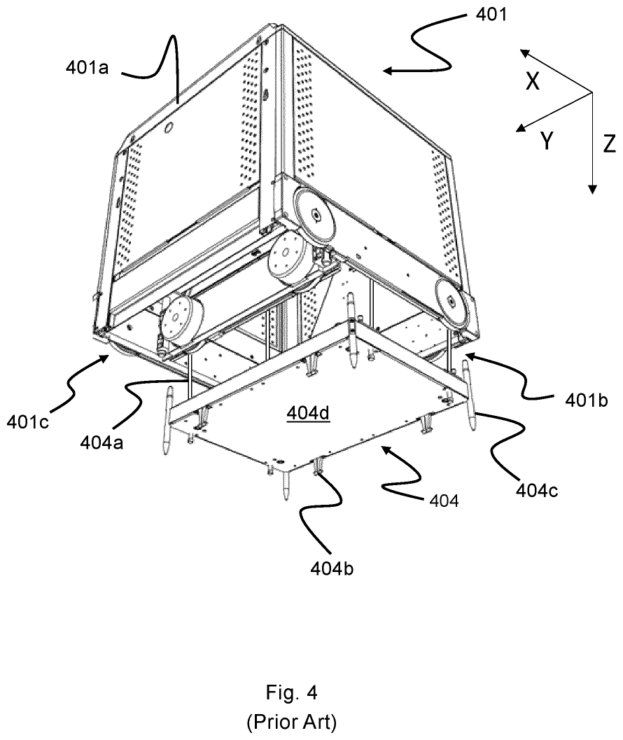

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

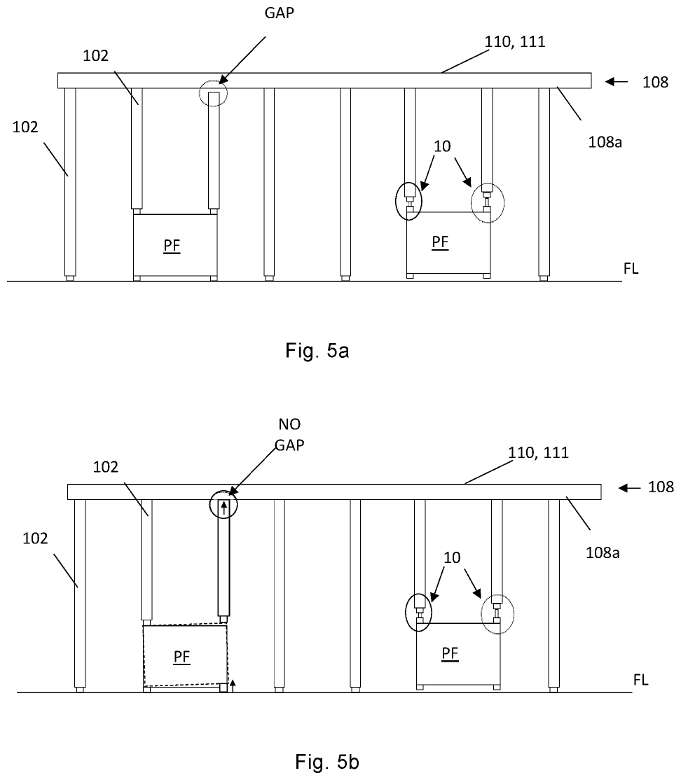

One embodiment of the automated storage and retrieval system according to the invention will now be discussed in more detail with reference to FIGS. 5-13.

It is now referred to FIG. 5a and FIG. 5b. Here, two port frames PF has been installed in the framework structure 100 by cutting upright members 102 (typically at least four upright members are cut) to a suitable length in order to insert each port frame PF into the space defined below the cut upright members 102. As shown to the left in FIG. 5a, there is a gap indicated as GAP between the upper end of one upright member 102 and the rail system 108. As discussed above, one way of removing the gap is to elevate one side of the port frame PF as shown on the left side of FIG. 5b. However, this will result in an unlevelled port frame, which may cause problems when operating the access station.

The present invention relates to an alternative solution for removing the gap is to use a framework adjuster 10 shown to the right in FIG. 5a and FIG. 5b. This framework adjuster 10 will be described more in detail below.

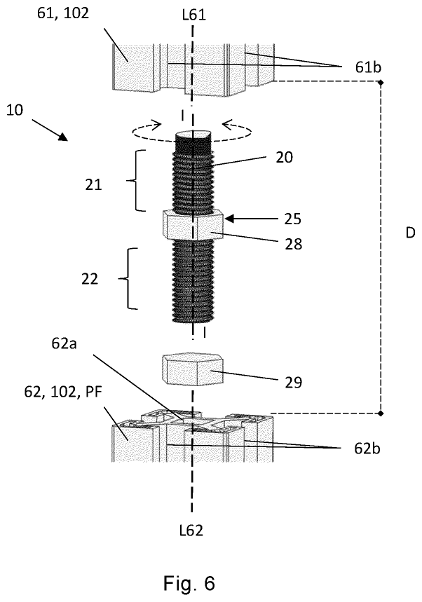

It is now referred to FIG. 6. Initially, it should be noted that in the description below, the framework adjuster 10 will be described to adjust a distance D between a first framework element 61 and a second framework element 62, where the first framework element 61 and the second framework element 62 may be any type of framework elements used in the framework structure 100 of the automated storage and retrieval system 1.

The first framework element 61 and the second framework element 62 may be upright members 102, horizontal members 103, a rail supporting member 108a for supporting a rail system 108, a port frame element PFE typically being a part of a port frame PF etc. The rail supporting member 108a may be integrated with the rails 110, 111 or may be a separate element supporting the rails 110, 111 from below.

Further examples will de described below.

### Example 1

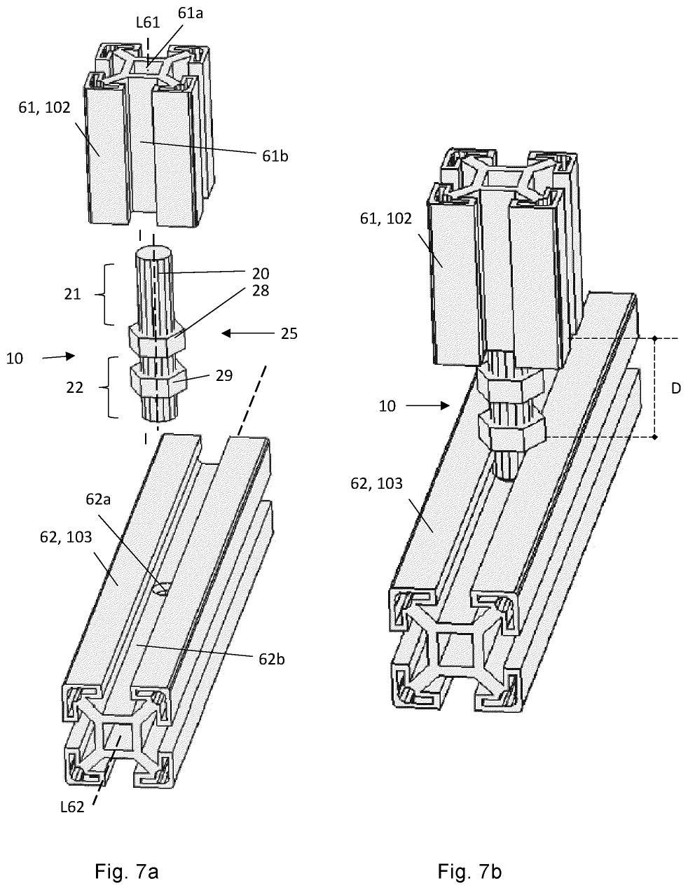

It is now referred to FIG. 6. Here it is shown that each framework element 61, 62 is oriented with their longitudinal directions L61, L62 aligned with each other. Each framework element 61, 62 has an opening 61a, 62a (reference number 62a is shown in FIG. 7a) oriented in their longitudinal directions. In addition, each framework element 61, 62 has a dovetail-shaped recess 61b, 62b also oriented in their longitudinal directions.

Each framework element 61, 62 is commercially available under the name Bosch Rexroth aluminum struts. These aluminum struts have a substantially square cross-sectional shape with a central opening and four recesses, one recess in each side surface.

The opening 61a of the first framework element 61 is referred to as the first opening 61a. while the opening 62a of the second framework element 62 is referred to as the second opening 62a. The recess 61b of the first framework element 61 is referred to as the first recess 61b. while the recess 62b of the second framework element 62 is referred to as the second recess 62b. The openings 61a, 62a are smooth, i.e. non-threaded.

In FIG. 6, the framework adjuster 10 is shown to comprise a double-threaded rod 20 defined with a longitudinal axis I-I having a first threaded section 21 threaded in a first direction, and a second threaded section 22 threaded in a second direction opposite of the first direction. The longitudinal axis I-I is aligned with the longitudinal direction L61 of the first framework element 61 and with the longitudinal direction L62 of the second framework element 62.

The first threaded section 21 is provided on a first end portion of the double-threaded rod 20, while the second threaded section 22 is provided on a second end portion of the double-threaded rod 20.

The first threaded section 21 of the double-threaded rod 20 is to be engaged in the first opening 61a of the first framework element 61 and the second threaded section 22 of the double-threaded rod 20 is to be engaged in the second opening 62a of the second framework element 62.

The first threaded section 21 and the second threaded section 22 are self-tapping threaded sections. Hence, the double-threaded rod 20 will create threads in the first opening 61a and the second opening 62a as the double-threaded rod 20 is driven into the openings 61a, 62a by rotation.

The framework adjuster 10 comprises an adjustment interface 25 for adjusting a distance D between the first framework element 61 and the second framework element 62 by rotation of the double-threaded rod 20.

In the present embodiment, the rod 20 is a double end threaded bolt with the adjustment interface 25 provided as a nut 28 fixed radially outside of the rod 20 in the border area between the first threaded section 21 and the second threaded section 22. The nut 28 is here fixed to the rod by welding or by an adhesive.

According to the above, a tool in the form of a wrench or plier may be engaged with the nut 28 in order to rotate the rod 20. When rotating the double-threaded rod 20 in the first direction (indicated as dashed arrow in FIG. 6), the first threaded section 21 will be driven into the first opening 61a while the second threaded section 22 will be driven into the second opening 62a, thereby decreasing the distance D. When rotating the double-threaded rod 20 in the second direction opposite (indicated as dashed arrow in FIG. 6) of the first direction, the first threaded section 21 will be driven out from the first opening 61a while the second threaded section 22 will be driven out from the second opening 62a, thereby increasing the distance D.

The framework adjuster 10 further comprises a locking nut 29 secured to the second threaded section 22. The position of the locking nut 29 may be adjusted relative to the second threaded section 22 for the purpose of locking the double-threaded rod 20 in place relative to the second framework element 62.

Hence, when the locking nut 29 is tightened up against the second framework element 62, e.g. through rotation of the locking nut, relative rotation between the double-threaded rod and the respective framework element 61, 62 is prevented. In this way, the distance D between the first and second framework elements 61, 62 that is controlled by the framework adjuster can be locked-in. Further rotation of the double-threaded rod relative to the first and/or second framework elements may be permitted by loosening the locking nut. The framework adjuster 10 may comprise a further locking nut (not shown) secured to the first threaded section 21.

In this example, the first framework element 61 and the second framework elements 62 are both upright members 102.

### Example 2

It is now referred to FIG. 7a and FIG. 7b. The framework adjuster 10 is similar to the first example above. Hence, only differences between the first and second example will be described in detail below.

In FIG. 7a, it is shown that the longitudinal axis I-I of the double-threaded rod 20 is aligned with the longitudinal direction L61 of the first framework element 61. However, the longitudinal axis I-I of the double-threaded rod 20 is perpendicular to the longitudinal direction L62 of the second framework element 62. It is further shown in FIG. 7a that the second threaded section 22 of the rod 20 is to be secured to an opening 62b perpendicular to the longitudinal direction L62 of the second framework element 62. The opening 62a may here be drilled into the framework element 62.

In this example, the first framework element 61 may be an upright member 102, while the second element 62 may be a horizontal member 103.

### Example 3

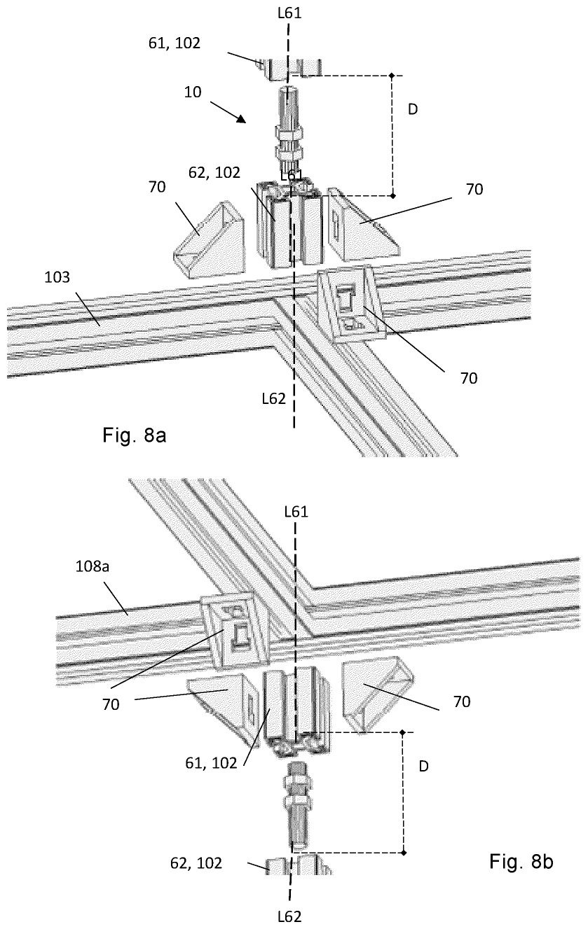

It is now referred to FIG. 8a. In this example, the framework adjuster 10 is used for the same purpose as in the second example above, i.e. to adjust the distance D between a horizontal member 103 and an upright member 102.

The first framework element 61 is here the upright member 102. It should be noted that only the lower part of the upright member 102 is shown in FIG. 8a.

The second framework element 62 is here a short upright member 102 secured to the horizontal member 103 by means of brackets 70.

By adjusting the distance D between the first framework element 61 and the second framework element 62, the distance between the horizontal member 103 and the upright member 102 is adjusted.

In this embodiment, it is achieved that both threaded ends of the framework adjuster 10 are secured to openings 61a, 62a oriented in the longitudinal directions L61, L62 of the framework elements 61, 62.

### Example 4

It is now referred to FIG. 8b. In this example, the framework adjuster 10 is used for the same purpose as in the second example above, i.e. to adjust the distance D between a horizontal member in the form of a rail supporting member 108a and an upright member 102.

The first framework element 61 is here a short upright member 102 secured to the rail supporting member 108a by means of brackets 70.

The second framework element 62 is here an upright member 102. It should be noted that only the upper part of the upright member 102 is shown in FIG. 8b.

By adjusting the distance D between the first framework element 61 and the second framework element 62, the distance between the rail supporting member 108a and the upright member 102 is adjusted.

Also in this embodiment, it is achieved that both threaded ends of the framework adjuster 10 are secured to openings 61a, 62a oriented in the longitudinal directions L61, L62 of the framework elements 61, 62.

### Example 5

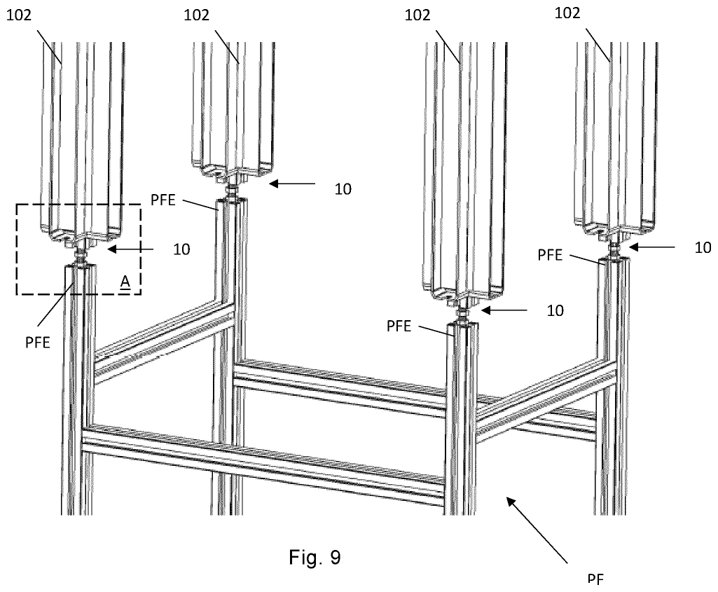

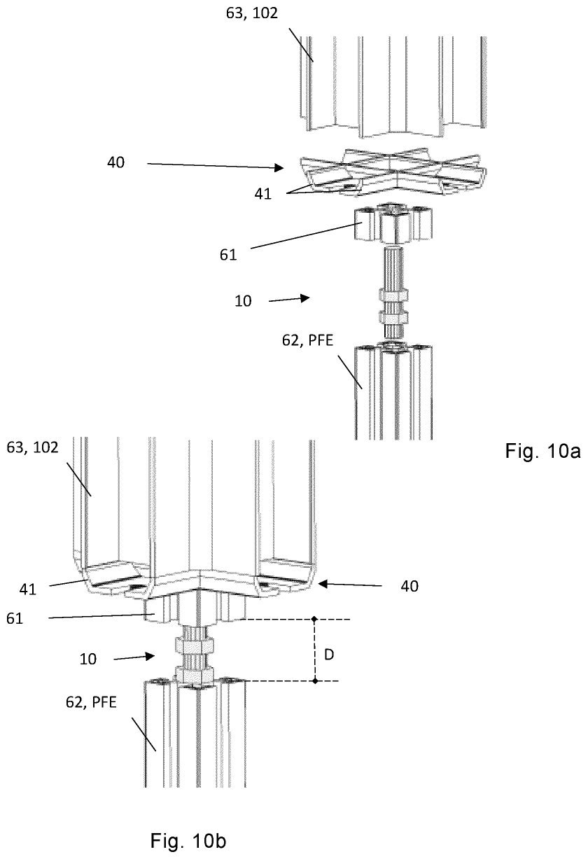

It is now referred to FIGS. 9, 10a and 10b. In this example, the framework adjuster 10 is used to adjust the distance between a port frame element PFE and a third framework element 63 in the form of an upright member 102. It should be noted that the port frame element PFE has a cross-sectional area being smaller than the cross-sectional area of the third framework element 63.

The first framework element 61 is here a short upright member 102 of similar dimensions as the port frame element PFE secured below the third framework element 63. The framework adjuster 10 comprises an adapter 40 for connecting the third framework element 63 to the first framework element 61.

The adapter 40 is shaped as an X or as a cross, and serves two main purposes. The first purpose is to transfer the load from the upright members 102 to the port frame PF. Hence, the adapter 40 is shaped to support the lower end of the upright members 102. The second purpose is to guide a storage container located in the access station within the port frame when elevating the storage container up from the access station and into the horizontal compartment defined by four upright members. For this purpose, each protruding part of the adapter has a wedge-shaped surface 41.

The second framework element 62 is here the port frame element PFE.

By adjusting the distance D between the first framework element 61 and the second framework element 62, the distance between the port frame element PFE and the third framework element 63 is adjusted.

In this example, there will typically be four or six pairs of port frame elements PFE and upright members 102, wherein one framework adjuster 10 is used to adjust the individual distance between the respective port frame elements PFE and upright members 102. Hence, the port frame PF itself can be adjusted to be horizontally by means of its adjustable legs (as indicated in FIG. 10a and FIG. 10b), while also the rail system 108 secured above the upright members 102 can be adjusted to be horizontally by means of the framework adjusters 10. It should be noted that some types of access stations will require that eight or even more upright members 102 are cut in order to install the access station.

### Example 6

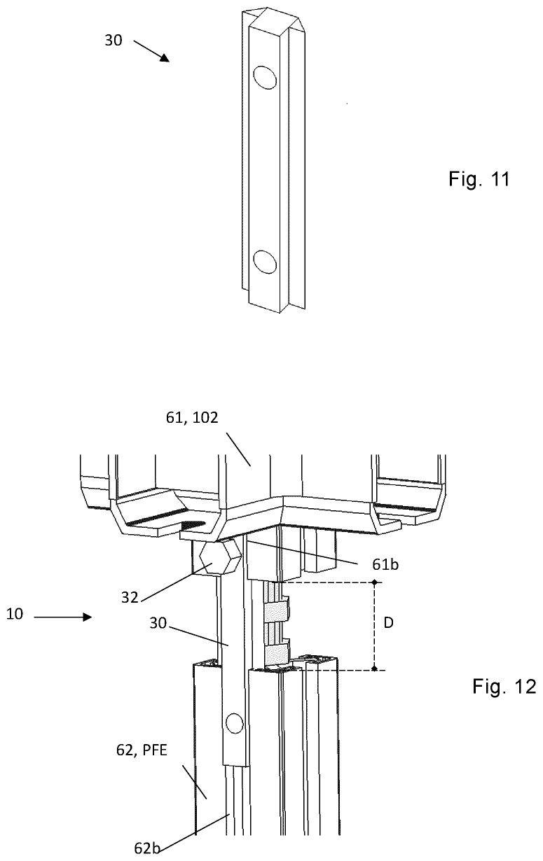

It is now referred to FIG. 11 and FIG. 12. This example corresponds to the fifth example above.

Here, the framework adjuster 10 comprises a guide element 30 having a dovetail-shaped cross-sectional shape engaged in the first longitudinal recess 61b and in the second longitudinal recess 62b. The purpose of the guide element 30 is to prevent relative rotation between the first framework element 61 and the second framework element 62 during adjustment of the distance D. Hence, the guide element 30 must be allowed to move relative to the first and/or the second longitudinal recesses 61b, 62b during adjustment. In FIG. 12, since the first longitudinal recess 61b is vertically aligned with the second longitudinal recess 62b, there is a risk that the guide element 30 will slide down and out of engagement with the upper longitudinal recess 61b. To avoid such unintentional sliding of the guide element 30 out of engagement with the first longitudinal recess 61b the framework adjuster 10 comprises a guide fastener 32 for securing the guide element 30 to the first longitudinal recess 61b.

### Alternative Embodiments

Yet some alternative embodiments will be described below.

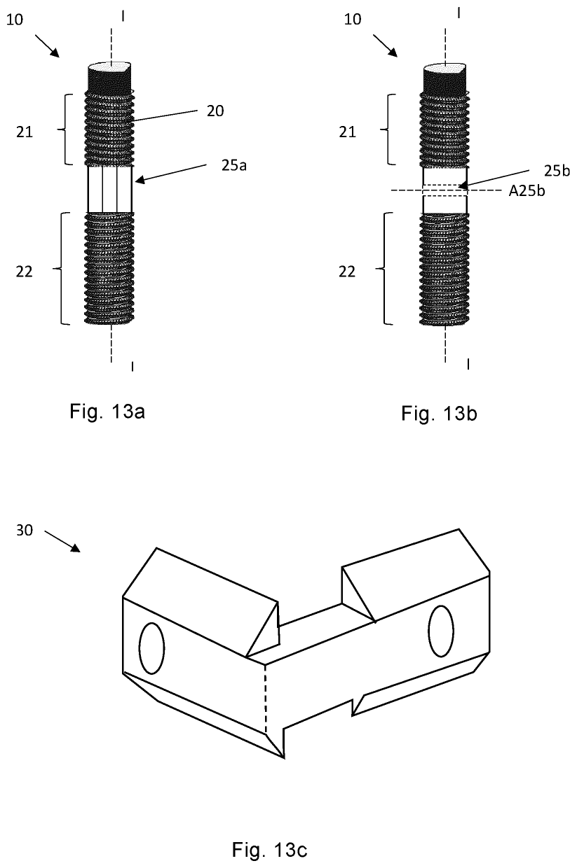

It is now referred to FIG. 13a. Here it is shown that the double-threaded rod 20 comprises a cross-sectional profile 25a provided in the outer surface of the rod 20. The cross-sectional profile 25a here has a hexagonal cross-section engagable by a tool in the form of a wrench or plier. Hence, the framework adjuster 10 does not need a nut 28 in order to rotate the rod 20.

It is now referred to FIG. 13b. Here, it is shown that the double-threaded rod 20 comprises a hole 25b provided in the double-threaded rod 20. The hole 25b has an orientation axis A25b perpendicular to the longitudinal axis I-I of the rod 20. The hole may be a recess formed in the rod into which a pin-shaped tool may be inserted or it may a through hole through which a pin-shaped tool may be inserted. Such a pin-shaped tool may be a screwdriver.

It is now referred to FIG. 13c. Here it is shown an alternative embodiment of the guide element 30. The guide element 30 of FIG. 13c may be used with the embodiment of FIG. 7a and FIG. 7b above, to prevent relative rotation between the first framework element 61 and the second framework element 62 during rotation of the double-threaded rod 20. The guide element 30 will here be stationary in the second longitudinal recess 62b during height adjustment, and must be allowed to slide within the first longitudinal recess 61b during adjustment.

In yet an alternative embodiment, the openings 61a, 62a may be provided with threads prior to engagement with the double-threaded rod so that the threaded sections of the rod may be threadedly engaged with the openings.

In the preceding description, various aspects of the framework adjuster and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
10 framework adjuster
20 double threaded rod
21 first threaded section
22 second threaded section
25 adjustment interface
25a cross-sectional profile
25b hole
28 nut
29 locking nut
30 guide element
32 guide fastener
40 adapter
61 first framework element
61a first opening
61b first recess
62 second framework element
62a second opening
62b second recess
63 third framework element
70 brackets
100 Framework structure
102 Upright members of framework structure
103 horizontal members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction
L61 longitudinal direction
L62 longitudinal direction
PF port frame
PFE port frame element

1. An automated storage and retrieval system comprising a framework structure comprising a first framework element having a first opening, a second framework element having a second opening, and a storage volume comprising storage columns for storing stacks of storage containers, wherein
the automated storage and retrieval system comprises a framework adjuster comprising a double-threaded rod having a first threaded section threaded in a first direction, and a second threaded section threaded in a second direction opposite of the first direction;
wherein the first threaded section of the double-threaded rod is engaged in the first opening of the first framework element and the second threaded section of the double-threaded rod is engaged in the second opening of the second framework element; and
wherein the framework adjuster comprises an adjustment interface for adjusting a distance between the first framework element and the second framework element by rotation of the double-threaded rod.

2. The automated storage and retrieval system according to claim 1, wherein:
the first threaded section is provided on a first end portion of the double-threaded rod;
the second threaded section is provided on a second end portion of the double-threaded rod; and
the adjustment interface is located between the first threaded section and the second threaded section.

3. The automated storage and retrieval system according to claim 1, wherein the adjustment interface comprises a cross-sectional profile provided in outer surface of the rod.

4. The automated storage and retrieval system according to claim 1, wherein the adjustment interface comprises a hole in the double-threaded rod.

5. The automated storage and retrieval system according to claim 1, wherein the adjustment interface is provided as an adjustment interface element fixed radially outside of the rod.

6. The automated storage and retrieval system according to claim 1, wherein the framework adjuster comprises a locking nut secured to the first threaded section or to the second threaded section, wherein the locking nut is configured to lock the double-threaded rod in place relative to the first framework element or the second framework element.

7. The automated storage and retrieval system according to claim 1, wherein:
the first framework element comprises a first longitudinal recess;
the second framework element comprises a second longitudinal recess; and
the framework adjuster comprises a guide element engaged in the first longitudinal recess and in the second longitudinal recess for preventing relative rotation between the first framework element and the second framework element.

8. The automated storage and retrieval system according to claim 7, wherein:
the first longitudinal recess and the first opening are parallel to each other; or
the second longitudinal recess and the second opening are parallel to each other.

9. The automated storage and retrieval system according to claim 7, wherein:
the first longitudinal recess and the first opening are perpendicular to each other; or
the second longitudinal recess and the second opening are perpendicular to each other.

10. The automated storage and retrieval system according to claim 7, wherein the guide element is slidably engaged in the first longitudinal recess or in the second longitudinal recess.

11. The automated storage and retrieval system according to claim 7, wherein the framework adjuster comprises a guide fastener for securing the guide element to the first longitudinal recess or the second longitudinal recess.

12. The automated storage and retrieval system according to claim 1, wherein the automated storage and retrieval system comprises:
a rail system provided on top of and supported by the framework elements on which container handing vehicles are operable and movable, wherein the distance between the first framework element and the second framework element of the framework structure, as set by the framework adjuster, is such that the rail system is aligned horizontally.

13. The automated storage and retrieval system according to claim 1, wherein the first threaded section and the second threaded section are self-tapping threaded sections.

14. A method for adjusting a distance between a first framework element and a second framework element of a framework structure of an automated storage and retrieval system, wherein the method comprises steps of:
engaging a first threaded section of a double-threaded rod into an opening of the first framework element, wherein the first threaded section is threaded in a first direction;
engaging a second threaded section of the double-threaded rod into an opening of the second framework element, wherein the second threaded section is threaded in a second direction opposite of the first direction;
rotating the double-threaded rod for adjusting the distance between the first framework element and the second framework element.

15. The method according to claim 14, wherein the step of rotating the double-threaded rod comprises:
rotating the double-threaded rod via an adjustment interface.

16. The method according to claim 15, wherein the step of rotating the double-threaded rod comprises:
rotating the double-threaded rod by means of a tool via the adjustment interface.

17. A method for installing a port frame in a framework structure of an automated storage and retrieval system, wherein the method comprises the steps of:
cutting first framework elements above a location for the port frame;
inserting the port frame into a compartment below the cut first framework elements;
engaging a first threaded section of a double-threaded rod into an opening of a respective one of the first framework elements, wherein the first threaded section is threaded in a first direction;
engaging a second threaded section of the double-threaded rod into corresponding openings of a respective second framework element of the port frame, wherein the second threaded section is threaded in a second direction opposite of the first direction;
rotating the double-threaded rod for adjusting a distance between the first framework element and the second framework element.
